(19) United States
(12) Patent Application Publication
(10) Pub. No.: US 2023/0392431 A1
(43) Pub. Date: Dec. 7, 2023

(54) DOOR STRUCTURE

(71) Applicant: JSG-GROUP OY, Tuorila (FI)

(72) Inventor: Jukka HINTIKKA, Tuorila (FI)

(21) Appl. No.: 18/248,940

(22) PCT Filed: Oct. 14, 2021
(86) PCT No.: PCT/FI2021/050683

§ 371 Date: Apr. 13, 2023

(30) Foreign Application Priority Data
Oct. 14, 2020 (FI) 20206004

(51) Int. Cl. E06B 1/52; E06B 3/36; E05B 13/00; E05B 63/14; E05B 65/06

(52) U.S. Cl. CPC E06B 1/526; E06B 3/36; E05B 13/005; E05B 63/143; E05B 65/06; E06B 2003/346

(57) ABSTRACT

Disclosed is a door structure including a first door frame, a second door frame, and door leaf. The door structure further includes a lock structure arranged to selectively lock the door leaf to the first door frame when the first door frame is open from the second door frame and to selectively lock the first door frame to the second door frame while the door leaf is open from the first door frame. Operating a first door handle causes the lock structure to lock the first door frame to the second door frame, and operating a second door handle causes the lock structure to lock the door leaf to the first door frame. Hinge frame portions of the door frames are arranged at the same side of the door leaf.

### FIELD OF THE INVENTION

The present invention relates in general to door structures. In particular, however not exclusively, the present invention concerns a double-action door.

### BACKGROUND

Double-action door structures are well known. They are used for example in restaurants as swinging doors, allowing the waiters to push the door to open from both sides. Such doors comprise a dual hinge on one side of the door. The gaps of the swinging door are very difficult to insulate with weatherstripping suitable for northern climate. Therefore, swinging doors are usually applied for indoor use only.

FI 128314 B discloses a double-action door comprising two nested door frames and a double-action door. An inner door frame is connected by a first set of hinges to a door leaf, allowing the door leaf to open from the inner door frame to a first direction. An outer door frame is connected by a second set of hinges to the inner door frame. The inner door frame may be opened, with the door leaf, to a second direction being opposite to the first direction. The sets of hinges are arranged at opposite sides of the door leaf relative to the direction of width of the door leaf. The door leaf is hinged along the first side to allow the door to pivot away from the doorway in the first direction, and the inner door frame is hinged along the second side to allow the inner door frame with the door leaf to pivot away from the doorway in the second direction.

### SUMMARY

An objective of the present invention is to provide a door structure. Another objective of the present invention is that the door structure is simpler than in the known solutions.

The objectives of the invention are reached by a door structure as defined by the respective independent claim.

According to a first aspect, a door structure is provided. The door structure comprises a first door frame defining a first opening for a door leaf, wherein the first door frame comprises a first hinge frame portion and a first lock frame portion arranged to be on opposite sides of the door leaf. The door structure also comprise the door leaf comprising a first door handle on a first side, wherein the first door handle is configured to operate a lock structure of the door structure, and a second door handle on a second side, wherein the second door handle is configured to operate the lock structure. Preferably, the first and the second door handles are arranged at the same side of the door leaf in the direction of the width of the door leaf, for example, substantially aligned in the direction of the thickness of the door leaf, although may be somewhat misaligned, such as up to 10 or 20 centimeters, for instance, in the direction of said width. The door structure also comprises at least one first hinge attached to the first hinge frame portion and to the door leaf, wherein the at least one first hinge is arranged to allow the door leaf to open only to a first direction.

Furthermore, the door structure comprises a second door frame comprising a second hinge frame portion and a second lock frame portion arranged to be on opposite sides of the door leaf and defining a space for the first door frame therebetween. The door structure also comprises at least one second hinge attached to the first hinge frame portion of the first door frame and to the second hinge frame portion of the second door frame, wherein the at least one second hinge is arranged to allow the first door frame to open only to a second direction being opposite to the first direction. The first hinge frame portion and the second hinge frame portion are arranged at the same side of the door leaf, preferably, in the direction of the width of the door leaf.

Still further, the lock structure is arranged to selectively lock the door leaf to the first door frame when the first door frame is open from the second door frame, and to selectively lock the first door frame to the second door frame while the door leaf is open from the first door frame. The lock structure is further arranged so that operating the first door handle causes the lock structure to lock the first door frame to the second door frame, and operating the second door handle causes the lock structure to lock the door leaf to the first door frame.

Preferably, the door structure, or specifically the lock structure thereof, is arranged so that opening the door leaf from the first door frame is prevented if the first handle is operated when the combination of the first door frame and the door leaf is open from the second door frame, for example, as a result of the second handle being operated earlier to open the combination. Alternatively or, preferably, in addition, the door structure is arranged so that opening the first door frame from the second door frame is prevented if the second handle is operated when the door leaf is open from the first door frame, for example, as a result of the first handle being operated earlier to open the door leaf.

In various embodiments, the lock structure may comprise means, for example, comprising a lock including bar(s) and/or electronic actuator(s) and/or latches, for selectively locking the door leaf to the first lock frame portion and means for selectively locking the first lock frame portion to the second lock frame portion.

The present invention provides a door structure. The present invention provides advantages over known solutions in that the door structure is simpler and operates reliably.

Various other advantages will become clear to a skilled person based on the following detailed description.

The terms “first”, “second”, etc. are herein used to distinguish one element from other element, and not to specially prioritize or order them, if not otherwise explicitly stated.

The exemplary embodiments of the present invention presented herein are not to be interpreted to pose limitations to the applicability of the appended claims. The verb “to comprise” is used herein as an open limitation that does not exclude the existence of also unrecited features. The features recited in depending claims are mutually freely combinable unless otherwise explicitly stated.

The novel features which are considered as characteristic of the present invention are set forth in particular in the appended claims. The present invention itself, however, both as to its construction and its method of operation, together with additional objectives and advantages thereof, will be best understood from the following description of specific embodiments when read in connection with the accompanying drawings.

### BRIEF DESCRIPTION OF FIGURES

Some embodiments of the invention are illustrated by way of example, and not by way of limitation, in the figures of the accompanying drawings.

FIGS. 1A-1E illustrate schematically a door structure according to an embodiment of the present invention.

FIGS. 2A-2C illustrates schematically a door structure according to an embodiment of the present invention.

### DETAILED DESCRIPTION OF SOME EMBODIMENTS

As those skilled in the art will appreciate, the examples of the door structure presented herein are suitable for application in a variety of different types of doorways, and are not limited to, for example, house entrances.

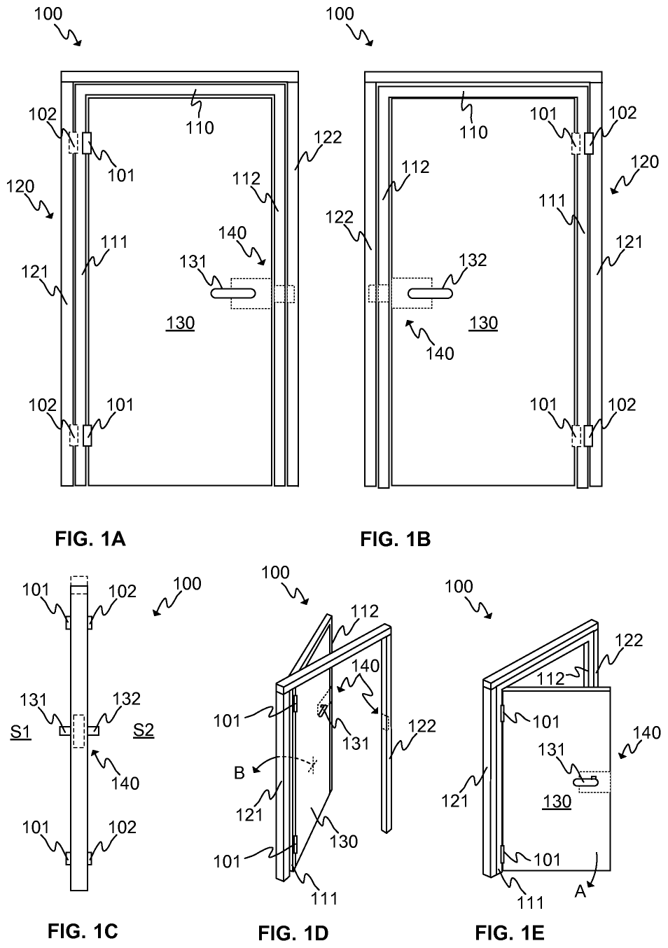

FIGS. 1A-1E illustrate schematically a door structure 100 according to an embodiment of the present invention. In FIGS. 1A-1C the door is closed. FIG. 1D shows the door being open in the second direction B. FIG. 1E shows the door being open in the first direction A.

Structures and/or components having dashed lines may be arranged either inside the door structure 100 or at the other side of the door structure 100.

The door structure 100 may comprise a first door frame 110 defining a first opening for a door leaf 130. The first door frame 110 may comprise a first hinge frame portion 111 and a first lock frame portion 112 arranged to be on opposite sides of the door leaf 130.

The door leaf 130 may comprise a first door handle 131 on a first side S1, wherein the first door handle 131 is configured to operate a lock structure 140 of the door structure 100, and a second door handle 132 on a second side S2, wherein the second door handle 132 is configured to operate the lock structure 140. The door structure 100 may also comprise the at least one first hinge 101 attached to the first hinge frame portion 111 and to the door leaf 130, wherein the at least one first hinge 101 is arranged to allow the door leaf 130 to open only to a first direction A.

The door leaf 130 may comprise a second door frame 120 comprising a second hinge frame portion 121 and a second lock frame portion 122 arranged to be on opposite sides of the door leaf 130 and defining a space for the first door frame 110 therebetween. Furthermore, at least one second hinge 102 is attached to the first hinge frame portion 111 of the first door frame 110 and to the second hinge frame portion 121 of the second door frame 120, wherein the at least one second hinge 102 is arranged to allow the first door frame 110 to open only to a second direction B being opposite to the first direction A. The first hinge frame portion 111 and the second hinge frame portion 121 may be arranged at the same side of the door leaf 130, preferably, in the direction of the width of the door leaf 130 as shown in FIGS. 1A-1E.

Furthermore, the lock structure 140 may be arranged to selectively lock the door leaf 130 to the first door frame 110 when the first door frame 110 is open from the second door frame 120 and to selectively lock the first door frame 110 to the second door frame 120 while the door leaf 130 is open from the first door frame 110. Furthermore, operating the first door handle 131, such as from a closed position thereof to an open position thereof, preferably causes the lock structure 140 to lock the first door frame 110 to the second door frame 120, and operating the second door handle 132, such as from a closed position thereof to an open position thereof, causes the lock structure 140 to lock the door leaf 130 to the first door frame 110.

Preferably, the door structure 100, or specifically the lock structure 140 thereof, is arranged so that opening the door leaf 130 from the first door frame 110 is prevented if the first door handle 131 is operated when the combination of the first door frame 110 and the door leaf 130 is open from the second door frame 120, for example, as a result of the second door handle 132 being operated earlier to open the combination. Alternatively or, preferably, in addition, the door structure 100 may be arranged so that opening the first door frame 110 from the second door frame 120 is prevented if the second door handle 132 is operated when the door leaf 130 is open from the first door frame 110, for example, as a result of the first door handle 131 being operated earlier to open the door leaf 130.

Thus, the door structure 100, or specifically the lock structure 140 thereof, may comprise determination means, such as including latches or the like, to determine or to indicate the situation when the combination of the first door frame 110 and the door leaf 130 is open into the second direction B. The determination may be based on mechanical or electrical means. Thereby the opening of the door leaf 130 from the first door frame 110 may be prevented even if the first door handle 131 would be operated when said combination is open. This may be based, for example, having the operation of latches related to the operation first 131 and the second door handle 132 being arranged to be at least functionally interconnected. On the other hand, the determination means may a separate device being functionally connected to the operation of the either one or both of lock mechanisms related to the operation of the first 131 and the second door handle 132.

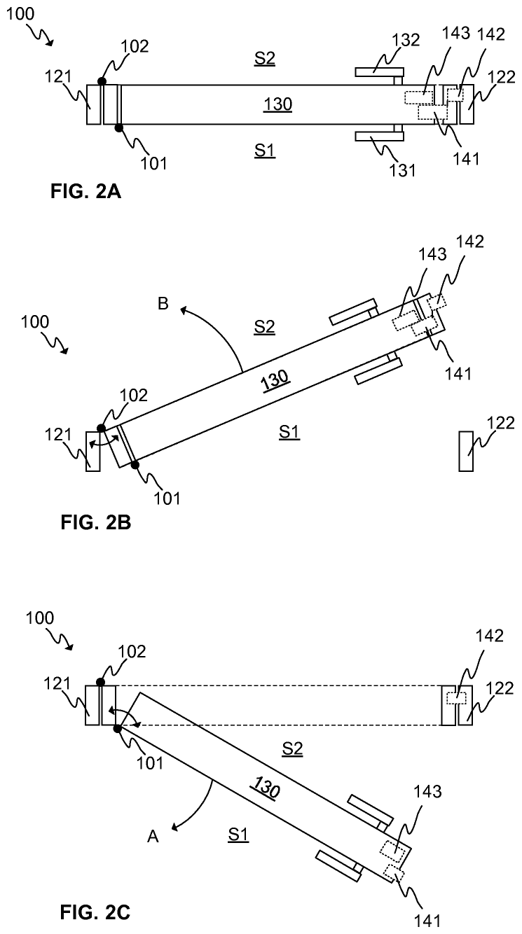

FIGS. 2A-2C illustrates schematically a door structure 100 according to an embodiment of the present invention. The door structure 100 is shown from above or below when the door is installed in its typical, however not the only possible, position. A portion of the first frame 110 extending between the first hinge frame portion 111 and the first lock frame portion 112 is shown with dashed lines in FIGS. 2A-2C.

The lock structure 140 may further comprise a first door handle 131 configured to operate the first latch 141 to lock or open the door leaf 130 to/from the first lock frame 112. The second door handle 132 may be configured to operate the second latch 142. The second latch 142 may extends through the first door frame 110 for engaging or releasing the first door frame 110 to/from the second door frame 120. The second latch 142 may be releasable from the lock structure 140.

In some embodiments, a bar 143 may operate the second latch 142 and/or the related mechanism in the first door frame 110 to execute the desired action. In one embodiment the first latch 141 and/or the second latch 142 are spring-loaded to engage the lock structure 140 when the door structure is closed. The bar 143 may detect the position of the spring-loaded first latch 141 and/or the second latch 142 by contact to adjust the lock structure 140 to correspond the state of the door structure 100.

The first door handle 131 or the second door handle 132 may reside only on one respective side of the door leaf 130 or extend to both sides of the door leaf 130.

As stated hereinbefore, the first hinge 101 is attached to the first hinge frame portion 111 and to the door leaf 130. The door leaf 130 pivots along the first hinge 101, wherein the opening direction of the door leaf 130 is limited to first direction A only. The limitation may be executed by the hinge mechanism as illustrated in FIGS. 2A-2C.

In some embodiments, the first door frame 110 may comprise a first threshold configured to limit the door leaf 130 movement to the first door frame 110. In one embodiment the first threshold is a platform for weatherstripping the door leaf 130, sealing it against elements of the climate. The number of the first hinges 101 or second hinges 102 installed is not limited, as the number of hinges may vary to carry the structural stress of the door structure.

In various embodiments, the first door frame 110 is inside the second door frame 120, said two door frames being nested. The second door frame 120 may be mounted to an opening in a building wall. The second door frame 120 may have, just as the first door frame 110 and as stated hereinbefore, at least two vertical portions comprising the second hinge frame portion 121 and the second lock frame portion 122. The second doorframe 120 has the two vertical portions in the same order to the first door frame 110. The door structure 100 may also comprise one or two further portions extending between the second hinge frame portion 121 and the second lock frame portion 122.

Opening direction of the door leaf 130 with the first door frame 110 is limited to one direction, to the second direction B only. The limitation may be executed by the hinge mechanism. In one embodiment, the second door frame 120 may comprise a second threshold configured to limit movement of the door leaf 130 and the first door frame 110. In one embodiment, the second threshold is a platform for weatherstripping the first door frame 110 onto the second door frame 120, sealing it against elements of the climate. The double-action door structure enables sealing the door properly.

The selective locking of the door in accordance with various embodiment prohibits both door elements to open simultaneously. The second door frame 120 is visualized as the outermost element. The first direction A pivots from the first hinge 101 and the second direction B pivots from the second hinge 102.

In one embodiment the lock structure 140 may comprise the bar 143 configured to transfer movement of the first door handle 131 to push the second latch 142 to lock the first door frame 110 to the second door frame 120. The bar 143 is one example of the means for locking selectively. The first door handle 131 locks the second direction B and opens the door leaf 130 to direction A.

As an example, when the user actuates the first door handle 131, the movement pushes the bar 143 towards the second latch 142. The movement may be linked via other components between the bar 143 and the second latch 142. In one embodiment, the bar 143 is configured to transfer movement of the first door handle 131 to pull the first latch 141 to open the door leaf 130 from the first door frame 110. The same movement of the user actuating the first door handle 131 may lock the first door frame 110 to the second door frame 120 and open the door leaf 130 from the first door frame 110. In one embodiment, the locking mechanism locks the first door frame 110 to the second door frame 120 before opening the door leaf 130 from the first door frame 110.

In one embodiment, the lock structure 140 comprises the bar 143 configured to transfer movement of the second door handle 132 to push the first latch 141 to lock the door leaf 130 to the first door frame 110. The second door handle 132 locks the first direction A and opens the combination of the door leaf 130 and the first door frame 110 to direction B. As an example, when the user actuates the second door handle 132, the movement pushes the bar 143 towards the first latch 141. The movement may be linked via other components between the bar 143 and the first latch 141.

In one embodiment, the bar 143 is configured to transfer movement of the second door handle 132 to pull the second latch 142 to open the first door frame 110 from the second door frame 120. The same movement of the user actuating the second door handle 132 may lock the door leaf 130 to the first door frame 110 and open the first door frame 110 from the second door frame 120. In one embodiment, the locking mechanism locks the door leaf 130 to the first door frame 110 before opening the first door frame 110 from the second door frame 120.

In one embodiment, the bar 143 is configured to disengage the first door handle 131 when the second door handle 132 is operated, and/or to disengage the second door handle 132 when the first door handle 131 is operated.

In some embodiments, the functionality of the lock structure 140, such as including the engaging and/or disengaging, is executed with at least one electronic actuator. Only one door handle, the first door handle 131 or the second door handle 132 may be used. When the door is opened to either direction A or B, disengaging the other door handle prevents the door structure 100 to open both the first latch 141 and the second latch 142 simultaneously. When the door structure is closed, the first handle 131 and the second handle 132 are engaged simultaneously. The first latch 141 and the second latch 142 activate the locking structure to engage both handles or the one that has been disengaged.

In one embodiment, functionalities of the bar 143 is divided into two bars configured to act as locking bars. A first locking bar is configured to transfer movement of the second door handle 132 to push the first latch 141 to lock the door leaf 130 to the first door frame 110 and a second locking bar is configured to transfer movement of the first door handle 131 to push the second latch 142 to lock the first door frame 110 to the second door frame 120. Having two locking bars may improve the lock structure reliability. The door handles 131, 132 may be interconnected to the locking bars allowing sequential actions, wherein operating the first door handle 131 or the second door handle 131 causes the locking action before the opening action.

Alternatively, or in addition, the controlling functionality of the lock structure 140 described herein can be performed, at least in part, by one or more hardware components or hardware logic components. An example of the control system described hereinbefore is a computing-based device comprising one or more processors which may be microprocessors, controllers or any other suitable type of processors for processing computer-executable instructions to control the lock structure 140 and/or transmit information or provide connection to other apparatuses. The computer-executable instructions may be provided using any computer-readable media that is accessible by a computing-based device.

Computer-readable media may include, for example, computer storage media, such as memory and communications media. Computer storage media, such as memory, includes volatile and non-volatile, removable and non-removable media implemented in any method or technology for storage of information, such as computer-readable instructions, data structures, program modules or other data. Computer storage media includes, but is not limited to, RAM, ROM, EPROM, EEPROM, flash memory or other memory technology, or any other non-transmission medium that can be used to store information for access by a computing device. In contrast, communication media may embody computer-readable instructions, data structures, program modules, or other data in a modulated data signal, such as a carrier wave, or other transport mechanism.

As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media is shown within the computing-based device, it will be appreciated that the storage may be distributed or located remotely and accessed via a network or other communication link, for example, by using a communication interface.

The steps described herein may be performed by software in machine-readable form on a tangible storage medium, e.g. in the form of a computer program comprising computer program code means adapted to perform all the stages of utilizing the door, such as related to the operation of the lock structure 140 thereof, described herein when the program is run on a computer and where the computer program may be embodied on a computer-readable medium. Examples of tangible storage media include computer storage devices comprising computer-readable media, such as disks, thumb drives, memory etc., and do not only include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

1. A door structure, comprising:
a first door frame defining a first opening for a door leaf, wherein the first door frame comprises a first hinge frame portion and a first lock frame portion arranged to be on opposite sides of the door leaf;
the door leaf comprising a first door handle on a first side, wherein the first door handle is configured to operate a lock structure of the door structure, and a second door handle on a second side, wherein the second door handle is configured to operate the lock structure;
at least one first hinge attached to the first hinge frame portion and to the door leaf, wherein the at least one first hinge is arranged to allow the door leaf to open only to a first direction;
a second door frame comprising a second hinge frame portion and a second lock frame portion arranged to be on opposite sides of the door leaf and defining a space for the first door frame therebetween;
at least one second hinge attached to the first hinge frame portion of the first door frame and to the second hinge frame portion of the second door frame, wherein the at least one second hinge is arranged to allow the first door frame to open only to a second direction being opposite to the first direction;
wherein the lock structure is arranged to selectively lock the door leaf to the first door frame when the first door frame is open from the second door frame and to selectively lock the first door frame to the second door frame while the door leaf is open from the first door frame;
wherein the first and second door handles are arranged on the opposite side of the door leaf relative to the first and second hinge frame portions in a direction of width of the door leaf; and
wherein the first hinge frame portion and the second hinge frame portion are arranged at the same side of the door leaf in the direction of width of the door leaf, wherein
the lock structure is configured so that operating the first door handle causes the lock structure to lock the first lock frame portion to the second lock frame portion, and operating the second door handle causes the lock structure to lock the door leaf to the first lock frame portion.

2. The door structure according to claim 1, wherein the lock structure comprises means for selectively locking the door leaf to the first lock frame portion and means for selectively locking the first lock frame portion to the second lock frame portion.

3. The door structure according to claim 1, wherein the lock structure comprises a bar configured to transfer movement of the first door handle to push a second latch to lock the first door frame to the second door frame.

4. The door structure according to claim 3, wherein the bar is configured to transfer movement of the first door handle to pull a first latch to open the door leaf from the first door frame.

5. The door structure according to claim 1, wherein the lock structure comprising a bar is configured to transfer movement of the second door handle to push a first latch to lock the door leaf to the first door frame.

6. The door structure according to claim 5, wherein the bar is configured to transfer movement of the second door handle to pull a second latch to open the first door frame from the second door frame.

7. The door structure according to claim 3, wherein the bar is configured to disengage the first door handle when the second door handle is operated to open the door leaf with the first door frame and to engage the first door handle when the door leaf with the first door frame is closed.

8. The door structure according to claim 3, wherein the bar is configured to disengage the second door handle when the first door handle is operated to open the door leaf and to engage the second door handle when the door leaf is closed.

9. The door structure according to claim 3, wherein the lock structure comprising at least two locking bars, wherein a first locking bar is configured to transfer movement of the second door handle to push a second latch to lock the door leaf to the first door frame and a second locking bar is configured to transfer movement of the first door handle to push a first latch to lock the first door frame to the second door frame.

10. The door structure according to claim 9, wherein the first locking bar and the second locking bar being interconnected, wherein operating the first door handle or the second door handle causes the locking action before the opening action.

11. The door structure according to claim 1, comprising a first electronic actuator configured to disengage the first door handle when the second door handle is operated to open the door leaf with the first door frame and to engage the first door handle when the door leaf with the first door frame is closed.

12. The door structure according to claim 1, comprising a second electronic actuator to disengage the second door handle when the first door handle is operated to open the door leaf and to engage the second door handle when the door leaf is closed.

13. The door structure according to claim 2, wherein the lock structure comprises a bar configured to transfer movement of the first door handle to push a second latch to lock the first door frame to the second door frame.

14. The door structure according to claim 2, wherein the lock structure comprising a bar is configured to transfer movement of the second door handle to push a first latch to lock the door leaf to the first door frame.

15. The door structure according to claim 3, wherein the lock structure comprising a bar is configured to transfer movement of the second door handle to push a first latch to lock the door leaf to the first door frame.

16. The door structure according to claim 4, wherein the lock structure comprising a bar is configured to transfer movement of the second door handle to push a first latch to lock the door leaf to the first door frame.

17. The door structure according to claim 4, wherein the bar is configured to disengage the first door handle when the second door handle is operated to open the door leaf with the first door frame and to engage the first door handle when the door leaf with the first door frame is closed.

18. The door structure according to claim 5, wherein the bar is configured to disengage the first door handle when the second door handle is operated to open the door leaf with the first door frame and to engage the first door handle when the door leaf with the first door frame is closed.

19. The door structure according to claim 6, wherein the bar is configured to disengage the first door handle when the second door handle is operated to open the door leaf with the first door frame and to engage the first door handle when the door leaf with the first door frame is closed.

20. The door structure according to claim 4, wherein the bar is configured to disengage the second door handle when the first door handle is operated to open the door leaf and to engage the second door handle when the door leaf is closed.
